(19) United States
(12) Patent Application Publication
(10) Pub. No.: US 2009/0111481 A1
(43) Pub. Date: Apr. 30, 2009

(54) METHOD FOR PREDICTING AIR INTERFACE CAPACITY BASED ON PERFORMANCE MEASUREMENTS

(75) Inventors: ISAAC SAMUEL, Swindon (GB); Monica Casado-Fernandez, Wiltshire (GB)

Correspondence Address: Jeffrey A. Pyle;WILLIAMS, MORGAN & AMERSON, P.C., Suite 1100, 10333 Richmond, Houston, TX, 77042, US

(73) Assignee: Lucent Technologies, Inc.

(21) Appl. No.: 12/208,451

(22) Filed: Sep. 11, 2008

Related U.S. Application Data
(63) Continuation of application No. 11/766,874, filed on Jun. 22, 2007, now abandoned.

(51) Int. Cl. H04W 72/08

(52) U.S. Cl. 455/452.2

(57) ABSTRACT

The present invention provides a method of wireless telecommunications in a wireless telecommunications network that provides a plurality of service types. The method includes accessing at least one first performance measurement associated with the wireless telecommunications network and determining at least one load associated with at least one of the plurality of service types based on the at least one performance measurement.

### BACKGROUND OF THE INVENTION

1. Field of the Invention

This invention relates generally to telecommunications systems, and, more particularly, to wireless telecommunication systems.

2. Description of the Related Art

Universal Mobile Telecommunication System (UMTS) networks are the third generation (3G) of personal mobile telecommunication. UMTS is a complex technology that mixes voice and multiple data rate services in the same terminal. A typical UMTS network includes many mobile units, such as cellular telephones, personal data assistants, laptop computers, and the like, in communication with one or more access points (e.g. base stations and/or node-Bs) via an air interface. The user of a mobile unit may be able to transmit and/or receive voice information and/or data information over the air interface. The UMTS data transfer protocols support data transfer at many data rates, which may range from rates as low as 8 kbps to rates as high as 384 kbps. UMTS also supports High Speed Downlink Packet Access (HSDPA), which is a packet-based data service on a Wideband Code Division Multiple Access (W-CDMA) downlink with data transmission at rates up to 8-10 Mbps over a 5 MHz bandwidth.

Deploying a UMTS network is costly, and service providers may not be willing to invest large amounts of capital to deploy a UMTS network having a capacity and/or coverage that may be larger than current demand for these services. Thus, many service providers have elected to deploy a basic UMTS network that is capable of providing good coverage at relatively small capacity, at least in part because the initial amount of traffic on the UMTS network is not expected to be large. For example, a UMTS network including a small number of base stations distributed far apart, i.e. the base stations may be separated by a large intersite distance, may be used to provide coverage to a large area but with a small maximum capacity. Traffic on the UMTS network is, however, expected to grow rapidly, which may force the service providers to upgrade the UMTS network to provide additional system capacity and/or coverage. Thus, the ability to anticipate the need for a system upgrade to increase capacity before the system performance begins to degrade due to the increased traffic may be very valuable to service providers.

The capacity of a UMTS network is very difficult to determine, at least in part because of the variety of services the UMTS network may be expected to provide. For example, in operation, a UMTS network may be expected to provide voice services, video services, 8 kbps data transfer, 16 kbps data transfer, 64 kbps data transfer rates, 128 kbps data transfer rates, HSDPA data transfer, and the like to a potentially large and unpredictable number of users. Connections in the UMTS network may be circuit-switched or packet switched for different users. Furthermore, each user may request a different, and unpredictable, mix of the provided services, and the resources needed to provide these services may change as the mobile unit moves. Since each service, and each mix of services, requires a different proportion of the UMTS network resources, the maximum capacity of the UMTS network, as well as the current consumption of the UMTS network resources, varies nearly constantly as users enter and exit the UMTS network (e.g., by new call requests, call terminations, and hand-offs) and request different services from the UMTS network.

Drive testing may be used to estimate the capacity of a UMTS network. During a typical drive test, a specially configured mobile unit moves throughout the coverage area of a portion of the UMTS network. For example, the specially equipped mobile unit can be carried in a van that drives through a cell associated with an access point of the UMTS network. The mobile unit may then request one or more services from the UMTS network and the resulting load on the network may be measured. Measurements associated with requests from different locations are then combined to estimate the capacity of the UMTS network. However, drive testing based on measurements associated with a single mobile unit (or a small number of mobile units) typically do not provide an accurate measurement of the capacity of the UMTS network under actual operating conditions. Furthermore, drive testing is labor-intensive and expensive.

The capacity of the UMTS network may also be estimated by comparing the UMTS network to existing networks. For example, the traffic on a newly deployed UMTS network may be estimated using the traffic measured for a pre-existing second-generation (2G) CDMA network in the same coverage area. However, estimates of the UMTS network capacity and/or resource consumption based on the traffic of a pre-existing network may not accurately predict the actual UMTS network capacity and/or resource consumption. For example, approximately 90% of the resources of a typical CDM network are devoted to voice users. In contrast, UMTS networks are expected to provide a much larger proportion of non-voice services. Thus, the UMTS network capacity and/or resource consumption may have a much stronger dependence on the behavior of non-voice traffic, for which little data from pre-existing networks may be available. Moreover, some UMTS networks may be deployed in geographical areas that do not currently have a pre-existing network.

The present invention is directed to addressing the effects of one or more of the problems set forth above.

### SUMMARY OF THE INVENTION

In one embodiment of the present invention, a method of wireless telecommunications in a wireless telecommunications network that provides a plurality of service types is provided. The method includes accessing at least one first performance measurement associated with the wireless telecommunications network and determining at least one load associated with at least one of the plurality of service types based on the at least one performance measurement.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a wireless telecommunications system, in accordance with the present invention;

FIG. 2 conceptually illustrates a method of determining loads associated with service types based upon one or more performance measurements, in accordance with the present invention;

FIG. 3A shows one exemplary embodiment of a data table including information indicative of values of performance measurement counters, in accordance with the present invention;

FIG. 3B shows one exemplary embodiment of a data table that may be used to store loads and/or capacities determined by the method shown in FIG. 2, in accordance with the present invention;

FIG. 4 shows one exemplary embodiment of a method of determining loads associated with service types in a wireless telecommunication system, in accordance with the present invention;

FIG. 5 conceptually illustrates one exemplary method for determining loads in a system that has no active bearers and/or is not currently providing any type of services, in accordance with the present invention;

FIG. 6 conceptually illustrates one exemplary embodiment of a method for determining loads associated with service types based upon performance measurements associated with a single service type, in accordance with the present invention;

FIG. 7 shows the result of observation of several intervals of time when 100% voice service is in a cell, in accordance with the present invention; and

FIG. 8 conceptually illustrates one exemplary embodiment of a method for determining loads associated with service types based upon performance measurements associated with a plurality of service types and/or active bearers, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

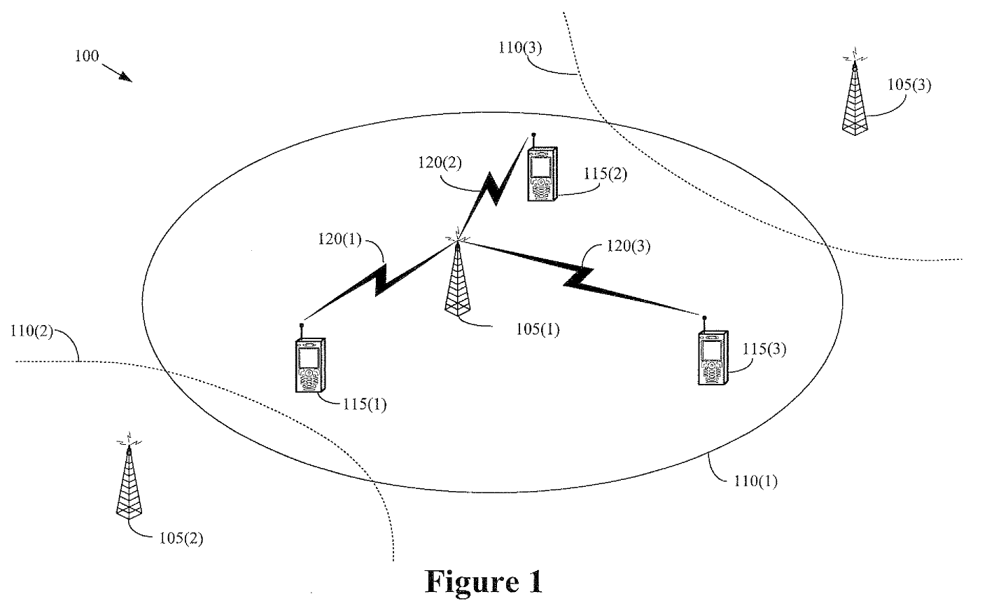

FIG. 1 conceptually illustrates one exemplary embodiment of a wireless telecommunications system 100. The wireless telecommunications system 100 may also be referred to as a wireless telecommunications network, or by any other similar term known to those of ordinary skill in the art. In the illustrated embodiment, the wireless telecommunications system 100 includes a plurality of access points or base stations 105(1-3) that may provide wireless telecommunications services within associated geographic areas or cells 110(1-3). The cells 110(1-3) are depicted in FIG. 1 as being partially overlapping. However, persons of ordinary skill in the art should appreciate that the cells 110(1-3) may overlap to a lesser or greater degree depending on the particular situation. It should also be appreciated that the present invention is not limited to the three base stations 105(1-3) and/or the three cells 110(1-3) shown in FIG. 1. In alternative embodiments, any desirable number of base stations 105(1-3) may provide wireless telecommunications services to any desirable number of cells 105(1-3). The wireless telecommunications network 100 may also include other elements not depicted in FIG. 1, such as base station controllers, radio network controllers, and the like.

The base station 105(1) may provide wireless telecommunications services to mobile units 115(1-3) over air interfaces 120(1-3). In the illustrated embodiment, the mobile units 115(1-3) are mobile telephones. However, persons of ordinary skill in the art should appreciate that the present invention is not limited to mobile telephones. In various alternative embodiments, the mobile units 115(1-3) may include other devices such as personal computers, laptop computers, personal data assistants, pagers, and the like, which may be in capable of communicating with the wireless telecommunications network 100.

The base station 105(1) may provide a plurality of types of wireless telecommunications services to the mobile units 115(1-3). In the illustrated embodiment, the base station 105(1) provides wireless telecommunications services to the mobile units 115(1-3) according to a Universal Mobile Telecommunications Service (UMTS) protocol. Thus, the provided wireless telecommunications service types may include voice services, video services, 8 kbps data transfer, 1.6 kbps data transfer, 64 kbps data transfer, 128 kbps data transfer, 384 kbps data transfer, and High Speed Downlink Packet Access (HSDPA) data transfer. However, persons of ordinary skill in the art having benefit of the present disclosure should appreciate that these wireless telecommunications services are intended to be exemplary and not to limit the present invention. In alternative embodiments, any desirable service type may be provided, including data transfer at different rates. For example, in various alternative embodiments, the wireless telecommunication system 100 may be a part of a broader network that includes any desirable combination of wireless and/or wired networks, such as other UMTS networks, a Plain Old Telephone Service (POTS) network, a Public Switched Data Network (PSDN), a Code Division Multiple Access (CDMA) network, a Global System for Mobile telecommunications (GSM) network, a Bluetooth network, a network based on one or more 802.11 protocols, and the like. These networks may provide different services than the UMTS network. Furthermore, connections in the UMTS wireless telecommunications network 100 may be circuit-switched or packet switched.

Users of the mobile units 115(1-3) may request services of particular types from the base station 105(1) as these service types are needed and/or desired. For example, if a user of the mobile unit 115(1) is engaged in a conversation with another user, the user of the mobile unit 115(1) may only request voice services from the base station 105(1). However, if a user of the mobile unit 115(2) is engaged in a video teleconference with one or more other users, the user of the mobile unit 115(2) may request voice services, video services, and perhaps one or more data transmission services from the base station 105(1). Accordingly, the base station 105(1) may be expected to provide a constantly and nearly instantaneously varying mix of services to a constantly and nearly instantaneously varying number of users. For example, at different times, the base station 105(1) may be idle because there are no active bearers, may be providing a single type of service to one or more mobile units 115(1-3), or may be providing multiple types of services to one or more mobile units 115(1-3). Predicting what services users of the mobile units 115(1-3) may request, and when the users may request these services, is difficult if not impossible. Accordingly, it may also be difficult or impossible to predict the capacity of the wireless telecommunication system 100.

The base stations 105(1-3) may access one or more performance measurements associated with the wireless telecommunications network 100. As used herein, the term “performance measurement” refers to a measurement indicative of the performance of the wireless telecommunication system 100. Performance measurements, and the registers and/or memory elements used to store them, are sometimes also referred to as performance measurement counters. The performance measurements may include measurements of maximum numbers of radio access bearers providing service of a particular type. For example, the performance measurement counter NumActRABMax.CSV12 counts the maximum number of radio access bearers requesting voice services in a given time period. Performance measurements may also include indications of such quantities as a number of users in the wireless telecommunication system, a mean number of active radio access bearers, a number of call requests, a number of dropped calls, a number of denied call requests, and the like. Performance measurements may also include information indicative of such quantities as a received signal strength indicator, a transmitted signal strength indicator, a percentage of average transmit power, a percentage of required power to support at least one common control channel, and the like. However, persons of ordinary skill in the art should appreciate that these particular performance measurements are intended to the illustrative and not to limit the present invention.

The base stations 105(1-3) can determine loads associated with the service types provided by the wireless telecommunication network 100 based on the performance measurements. In one embodiment, the base stations 105(1-3) may also determine a capacity of the wireless telecommunication network 100 using the loads and/or the performance measurements, as will be discussed in detail below. In the interest of clarity, this discussion assumes that the functionality for performing these operations resides in one or more of the base stations 105(1-3). However, persons of ordinary skill in the art having benefit of the present disclosure should appreciate that this functionality may reside in any desirable device or devices. Furthermore, these functions may be implemented hardware, software, or any desirable combination thereof.

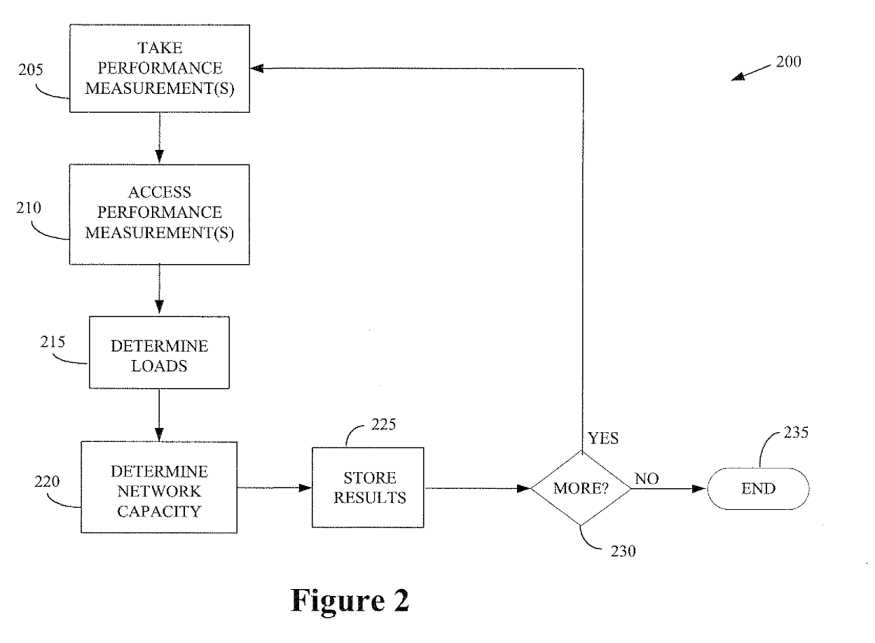

FIG. 2 conceptually illustrates a method 200 of determining loads associated with service types based upon one or more performance measurements. One or more performance measurements associated with a wireless telecommunication system are taken (at 205). Techniques for taking (at 205) one or more performance measurements are known to persons of ordinary skill in the art and, in the interest of clarity, will not be discussed further herein. One or more of the performance measurements are then accessed (at 210). In one embodiment, the one or more performance measurements may be accessed (at 210) from a table that stores the performance measurements.

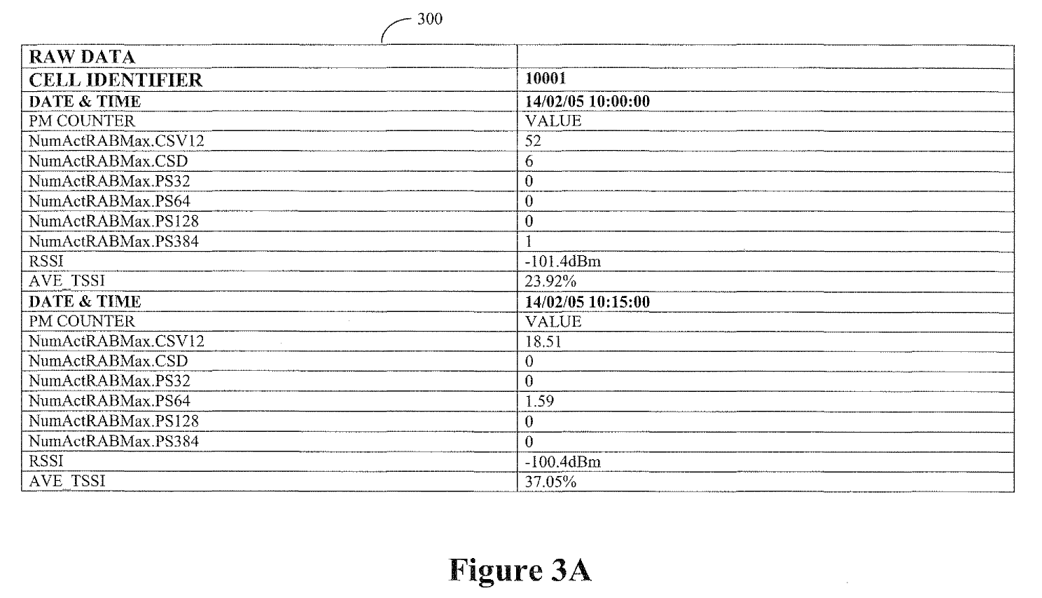

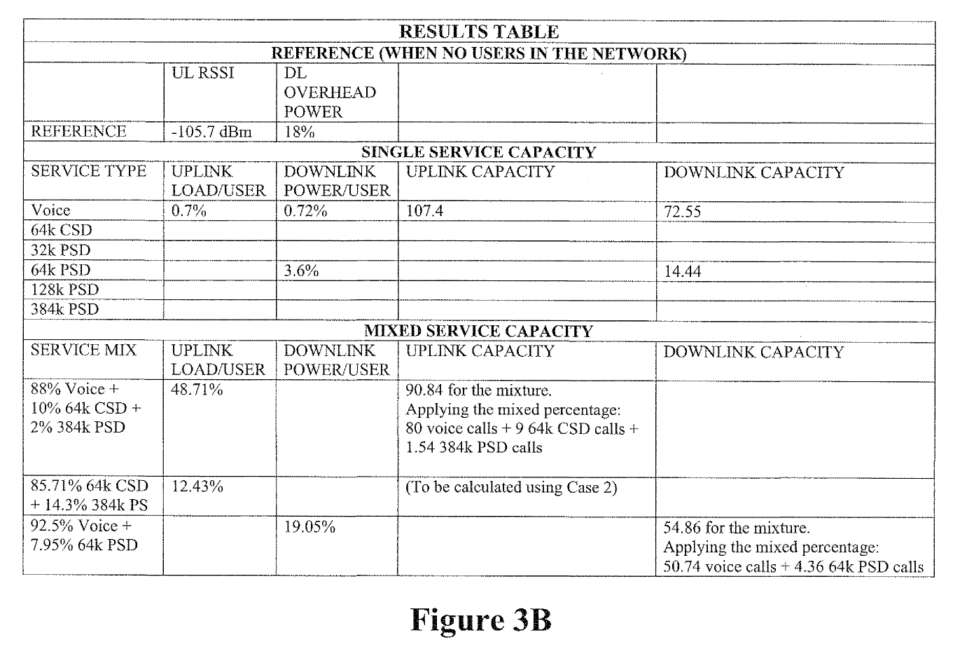

FIG. 3A shows one exemplary embodiment of a data table 300 including information indicative of values of performance measurement (PM) counters. The entries in the data table 300 indicate that the associated wireless telecommunication system has a maximum number of active radio access bearers using voice services (NumActRABMax.CSV12) of 52, a maximum number of active radio access bearers using circuit switched data services (NumActRABMax.CSD) of 6, a maximum number of active radio access bearers using 32 kbps data services (NumActRABMax.PS32) of 0, a maximum number of active radio access bearers using 64 kbps data services (NumActRABMax.PS64) of 0, and a maximum number of active radio access bearers using 384 kbps data services (NumActRABMax.PS384) of 1. The data table 300 also indicates that the received strength signal indicator (RSSI) has a value of about −105.7 dBm and an average transmitted signal strength indicator (AVE_TSSI) has a value of about 23.92%. In this embodiment, the AVE_TSSI is expressed as a percentage of the transmitted power from a cell, e.g. the AVE_TSSI=23.92% means that the cell is transmitting 23.92% of the power amplifier.

Referring back to FIG. 2, loads associated with one or more of the service types of the wireless telecommunication network are determined (at 215). Techniques for determining (at 215) the loads associated with one or more of the service types will be discussed in detail below. In one embodiment, a capacity of the wireless telecommunication network may be determined (at 220) based on the loads and/or one or more performance measurements. Techniques for determining (at 220) the network capacity will be discussed in detail below. The loads and/or capacities may then be stored (at 225). For example, the loads and/or capacities may be stored (at 225) in a table.

FIG. 3B shows one exemplary embodiment of a data table 310 that may be used to store a resource allocation and/or capacities determined by the method 200 shown in FIG. 2. The data table 310 includes resource allocations and capacities that are determined at two separate times, as indicated by the strings “14/02/05 10:00:00” and “14/02/05 10:15:00” shown in the data table 310. The 15-minute time difference corresponds to the time between two performance measurements. Persons of ordinary skill in the art having benefit of the present disclosure should appreciate that, in alternative embodiments, the data table 310 may include resource allocations and/or capacities determined at any desirable number of times and time intervals.

In the illustrated embodiment, the data table 310 includes values indicative of the reference measurements of the noise floor for the uplink and the overhead power allocated in the downlink. The data table 310 also includes values indicative of resource allocation associated with voice services, 32 kbps data services, 64 kbps data services, 128 kbps data services, and 384 kbps data services. The resource allocation stored in data table 310 includes an uplink load per user associated with each service type, a downlink power consumption associated with each service type, maximum uplink capacity associated with each service type and a maximum downlink capacity associated with each service type. In the illustrated embodiment, the uplink load per user is presented as a percentage of the maximum system load and the downlink power consumption is presented as a percentage of power required from the power amplifier. However, in alternative embodiments, any desirable representation of the loads may be used. The maximum uplink and downlink capacities are presented as a number of allowable uplink and downlink calls. However, any desirable information indicative of these capacities may be used. The data table 310 also includes information indicative of uplink and downlink resource allocation and capacity associated with mixture of services experienced in the network.

Referring back to FIG. 2, if it is determined (at 230) the wireless telecommunication system is in operation, then more performance measurements may be taken (at 205). In one embodiment, a wireless telecommunication system may take (at 205) additional performance measurements approximately every 15 minutes. However if it is determined (at 230) that the wireless telecommunication system is no longer in operation, or additional performance measurements are not expected to be taken (at 205) for some other reason, then the method 200 may end (at 235).

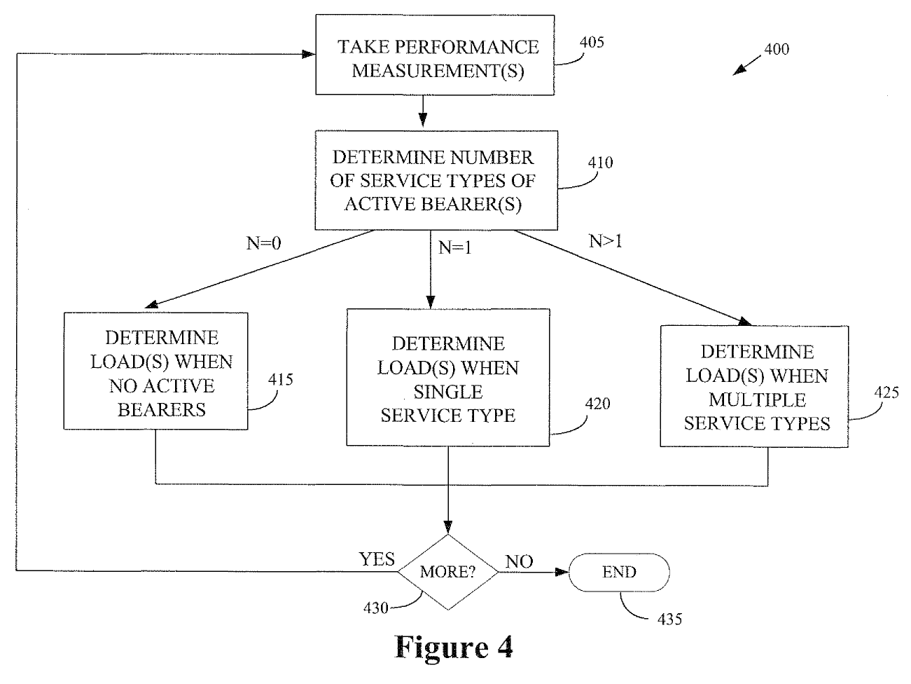

Illustrative embodiments of techniques for determining loads and/or capacities for service types in a wireless telecommunication system based on performance measurements are discussed below with reference to FIGS. 4-8. In the illustrated embodiments, the methodology relates theoretical relationships for the technology with the performance measurements obtained from the real network. In the interest of clarity and ease of explanation, the embodiments discussed below are presented in the context of relatively simple examples. However, modifying and/or extending these examples to more complicated systems, such as may be deployed by wireless telecommunication service providers, should be a routine undertaking to persons of ordinary skill in the art having benefit of the present disclosure.

Determining the service type loads and/or system capacities may include both uplink and downlink analyses. In one embodiment, the uplink analysis compares a noise rise that is measured in the system periodically to performance measurements indicative of traffic in the cell at approximately the same time. The capacity of the uplink may be limited by the noise rise relative to the noise floor received at a base station, such as the base station 105(1) shown in FIG. 1, or other Node-B. The signal level at the base station may be measured as a Received Signal Strength Indicator (RSSI) at the base station. The RSSI measures the wide band signal received at the base station, and the wide band signal includes the signal from all the served mobiles, the noise signal from mobiles in other networks, the thermal noise and other noise sources. Performance measurement counters may be used to capture the maximum RSSI at the base station. The interference in the uplink may include same cell interference from other mobile units the same cell. For example, the same cell interference, I, may be given by:

I=αE_{b}R(N−1),

where α is an activity of the users in the cell, E_{b} is an energy per bit, R is a bit rate, and N is the number of users in the cell. Interference in the uplink may also come from mobile units in neighboring cells, thermal noise, and noise from other sources external to the network.

The relation between the current capacity in the network and the maximum capacity on the uplink may be given by:

$$Loading ≡ η = \frac{N}{{N}_{pole}} = 1 - \frac{1}{{Δ}_{N} ( 1 + \frac{1}{K} )}$$

where N represents a current capacity, Nₚₒₗₑ represents a maximum capacity, and:

$$NoiseRise ≡ {Δ}_{N} = \frac{{I}_{o}}{{N}_{o}} = \frac{RSSI}{{RSSI}_{floor}} .$$

In these equations, the minimum noise in the network, RSSI_{floor}=NₒW, where Nₒ is a noise and W is a bandwidth, such as 5 MHz in UMTS. The RSSI_{floor} is typically dominated by a thermal noise component. The quantity K is approximately a constant given by:

$$K = \frac{\frac{W}{R}}{\frac{{E}_{o}}{{N}_{o}} \cdot α \cdot ( 1 + f )}$$

In one embodiment, the constant K may be neglected for low data rates.

In the downlink direction, the main resource that defines both coverage and capacity is the cell power, but this resource is shared between coverage and capacity, and thus it may be difficult to be partial to either one. In general, the capacity may depend on the achievable coverage and vice versa. The downlink capacity may have a high dependency on interference, since the required power for a particular mobile unit depends on the amount of interference that the mobile unit is experiencing. Moreover, the downlink interference may depend on the mobile unit location and the location of the source(s) of interference, hence making the downlink analysis more complicated then the uplink. Beside the location and interference, the power per user may also depend on velocity, multipath scenario, and fading.

In one embodiment, the maximum cell capacity can be computed based on an observed average transmit signal strength indicator (AVE_TSSI), which corresponds to the average transmitted power from the cell. The maximum cell capacity may also be computed based on the average number of active radio access bearers (RABs) in the same cell at the same period of time. In one embodiment, the maximum recommended capacity may be reached when blocking due to lack of power starts occurring in the cell. In one embodiment, the blocking for acceptable quality is about 2%. Accordingly, the maximum downlink capacity, DLMaxCapacity, may be given by:

$$DLMaxCapacity = \frac{{\sum }_{k = 0}^{NumServ} {NumActRABMean}_{k}}{( \begin{matrix}AVE\_TSSI - \\ CommonChannelsPower\end{matrix} )} \cdot ( 70 - CommonChannelPower )$$

where NumActRABMeanₖ is a performance measurement counter for the mean number of active radio access bearers (RABs) in the network for service type k, NumServ is a performance measurement counter indicating the number of services provided by the network, AVE_TSSI is a performance measurement counter for the percentage of average transmitted power from the sector with respect to the power amplifier capability, and CommonChannelsPower corresponds to the percentage of required power to support all the common control channels. In the above embodiment, the default value for CommonChannelsPower is 23%, but it can be lower if the load in the cell is very light. The current value of CommonChannelsPower in the network can be found by observing AVE_TSSI in the cell when no users are active, as will be discussed in detail below.

In one embodiment, the uplink and downlink analyses may be done in parallel to determine which link will reach its capacity limit earlier. Moreover, knowledge from previous performance measurements on either the uplink or the downlink may be used to determine a noise contribution associated with separate service types of the traffic. A learning technique may also be applied to the periodic results to improve accuracy and/or reliability of later performance measurements on either the uplink or downlink, as will discussed in detail below.

Referring now to FIG. 4, one exemplary embodiment of a method 400 of determining loads associated with service types in a wireless telecommunication system is shown. The method 400 may also be used to determine a capacity of the wireless telecommunication system, as will be discussed in detail below. One or more performance measurements are taken (at 405). Exemplary performance measurements that may be taken (at 405) are discussed above. One or more numbers of service types associated with active hearers in the wireless telecommunication system are then determined (at 410). In one embodiment, the number of service types associated with the active bearers is determined (at 410) using one or more performance measurement counters. For example, a maximum number of active radio access bearers using voice services may be determined (at 410) using the performance measurement counter NumActRABMax.CSV12.

If there are no active bearers, i.e. N=0, then the loads may be determined (at 415) for a system that is not currently providing any service types. If all of the active bearers are using a single service type (N=1), such as voice communication, then one or more loads may be determined (at 420) based upon performance measurements associated with the single service type. If the active bearers are using more than one service type (N>1), such as voice communication and data communication at one or more data transfer rates, and one or more loads may be determined (at 425) based upon performance measurements associated with the plurality of service types. Exemplary techniques for determining (at 415) loads when no active bearers are present, determining (at 420) loads when a single service type is present, and determining (at 425) loads when multiple service types are present will be discussed in detail below.

Once the loads have been determined (at 415, 420, or 425), whether or not more performance measurements have been taken (at 405), or are expected to be taken (at 405), may be determined (at 430). If it is determined (at 430) that more performance measurements are to be taken (at 405), then the method 400 may return to step 405. However, if it is determined (at 430) that no more performance measurements are to be taken (at 405), or are expected to be taken (at 405), the method 400 may end (at 435).

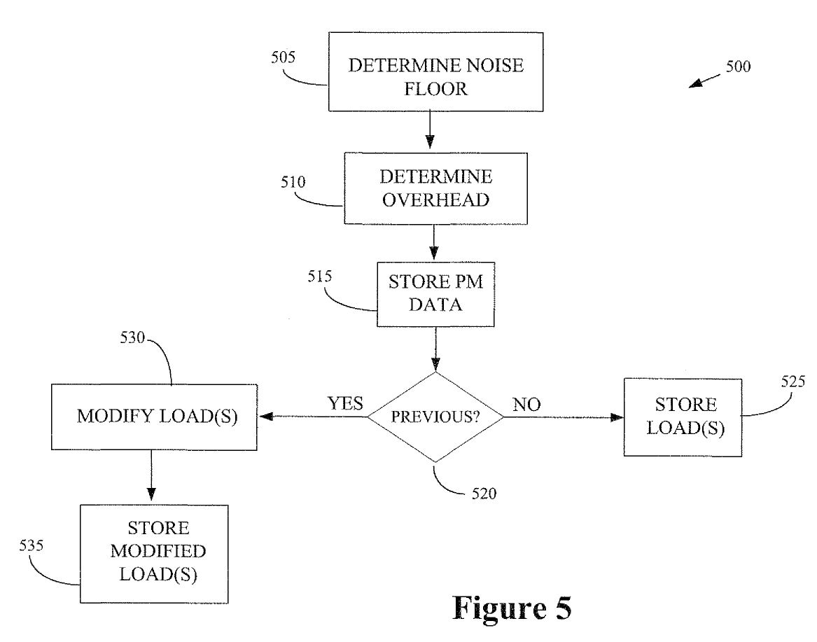

FIG. 5 conceptually illustrates one exemplary method 500 for determining loads in a system that has no active bearers and/or is not currently providing any type of services. A load corresponding to a noise floor may be determined (at 505). In one embodiment, a performance measurement corresponding to the minimum noise in the network, RSSI_{floor}, taken when there are no active bearers and/or no service types being provided, may be used to determine (at 505) the noise floor. An overhead may be determined (at 510). In one embodiment, the overhead may be determined (at 510) based on an observed average transmit signal strength indicator (AVE_TSSI), which corresponds to the average transmitted power from the cell, taken when there are no active bearers and/or no service types being provided.

The performance measurement data may be stored (at 515). For example, the performance measurement data may be stored (at 515) in the table such as the data table 300 shown in FIG. 3A. Whether or not previous measurements have been taken during periods when there are no active bearers and/or no service types being provided is determined (at 520). If no previous measurements have been taken, then the determined loads, e.g. the noise floor and/or overhead, may be stored (at 525). For example, the loads may be stored (at 525) in a table such as the results table 310 shown in FIG. 3B. If previous measurements have been taken, then the determined loads, e.g. the noise floor and/or overhead, may be modified (at 530). In various alternative embodiments, modifying (at 530) the loads may include forming various statistical combinations of the current loads and the previously determined loads. For example, the statistical combinations may be formed by learning algorithms that perform operations including, but not limited to, means, medians, window functions, weighting functions, and the like. The modified loads may then be stored (at 535). For example, the modified loads may be stored (at 525) in a table such as the results table 310 shown in FIG. 3B.

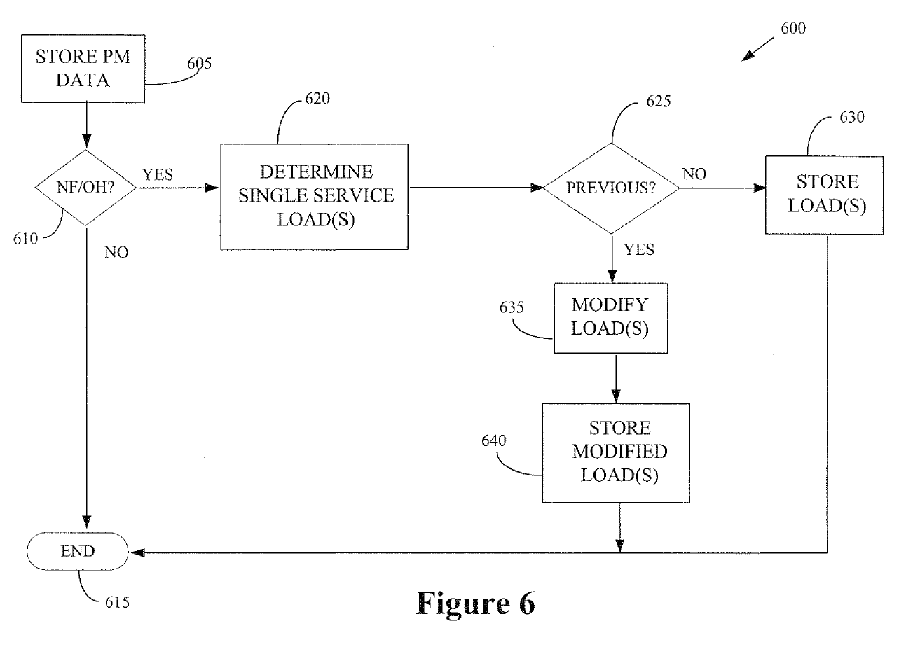

FIG. 6 conceptually illustrates one exemplary embodiment of a method 600 for determining loads associated with service types based upon performance measurements associated with a single service type. Since PM counters are typically taken every 15 minutes it is possible to find some periods of time where only one type of call is in the network, these periods are very valuable to find the load that a single service introduces into the network. This provides useful information that can be used when there is a mixture of services in the network.

In the illustrated embodiment, the performance measurement data is stored (at 605), e.g. in a table such as the data table 300 shown in FIG. 3A. If it is determined (at 610) that there are no previous performance measurements available from time periods when the system had no active bearers and/or was providing no types of service, then the method 600 may end (at 615). If it is determined (at 610) that there are previous performance measurements available from time periods when the system had no active bearers and/or was providing no types of service, then one or more loads may be determined (at 620) using the performance measurements associated with a single service type. For example, if one or more previous measurements of a noise floor and/or an overhead are available, then one or more loads may be determined (at 620) using the performance measurements associated with a single service type.

In one embodiment, one or more loads may be determined (at 620) for an uplink. The load in the network may be determined (at 620) using the RSSI measurements from performance measurement counters, where the RSSI counter provides the maximum RSSI measured in a period of time. Since a previous measurement of the noise floor is available, the current noise floor may be determined by overserving the RSSI measurements when no calls are in the network. In some embodiments, the RSSI value may fluctuate due to the tolerance in the measurements, fluctuating external noise sources, temperature changes, and the like. The noise floor can be obtained as the median (the value that repeats the most, therefore it avoids the effect of spurious noise) of the observed RSSI when no mobile units are in the network. The load, η, can be obtained from the RSSI performance measurement counter as:

$$Loading ≡ η \\ = \frac{N}{{N}_{pole}} \\ = 1 - \frac{1}{{Δ}_{N} ( 1 + \frac{1}{K} )} \\ ≅ 1 - \frac{1}{{Δ}_{N}} \\ = 1 - \frac{{RSSI}_{floor}}{{RSSI}_{actual}}$$

Note that in this equation both RSSI values are expressed in linear domain. If the data rate is small, as voice 12.2 k for example, the K factor can be neglected, otherwise an error may be introduced in the load calculation. The K factor for large data rates, such as 128 k or 384 k data transfer rates, can be approximated by theoretical values or it could be obtained by knowledge of exact channel profile or E_{b}/Iₒ value, and other cell interference and/or activity factors. In one embodiment, this knowledge can be learned by observing the performance measurement counters through a long period of time.

Once the number of calls in the cell and the actual load is obtained, the maximum capacity can be obtained. The maximum number of simultaneous active calls in the cell can be obtained from the performance measurement counter NumActRABMax of the particular service, for example, the ‘NumActRABMax.CSV12’ counter in case of voice service. Since the measured RSSI in the period of time corresponds to the maximum, it would add more accuracy to the calculation to relate it to the maximum number of RABs instead of the mean, although the present invention is not limited to using the maximum number of RABs. The following expressions can be used to calculate the maximum capacity in the example of voice, Nₘₐₓ_{_{—}}_{recommended}:

$$Loading ≡ η \\ = \frac{N}{{N}_{pole}} ⇒ {N}_{pole} \\ = \frac{NumActRABMAX \cdot CSV 12}{η} ⇒ {N}_{max , recommended} \\ = 0.75 {N}_{pole}$$

In the above equation, 75% is the maximum recommended load to avoid overload and blocking problems in the network. Again, this value can be verified for each particular cell by observing the performance measurement counter that shows the blocking in the network as function of the actual load in the network. A graph of “NumActRABMax” for a single service vs. the actual calculated load can be very useful to observe the standard deviation of the measurements in the network due to fluctuations in the total interference. Measurements may need to be analyzed for a long period of time in order to be able to get a good accuracy.

As one example of determining (at 620) a load on an uplink, periods with only 100% voice 12.2 k are analyzed, i.e. only “NumActRABMax.CSV12” is higher than 0, the other “NumActRABMax” performance measurement counters are equal to zero. The minimum RSSI (RSSIₘᵢₙ) has been found when no mobile units are in the network. The median of all measurements corresponds to −105.7 dBm. The load is determined (at 620) as follows. Since the RSSI is given in dBm, the RSSI may be converted to a linear value:

$${rssi}_{min\_linear} = {10}^{\frac{- {RSSI}_{min , dBm} - 30}{10}} = {10}^{\frac{- 105.7 - 30}{10}}$$

$${rssi}_{actual\_linear} = {10}^{\frac{- {RSSI}_{actual , dBm} - 30}{10}} = {10}^{\frac{- 101.4 - 30}{10}}$$

$$Loading ≡ η \\ = 1 - \frac{{rssi}_{min\_linear}}{{rssi}_{actua\_linear}} \\ = 1 - {10}^{\frac{{rssi}_{min\_linear} - {rssi}_{actua\_linear}}{10}} \\ = 1 - {10}^{\frac{101.4 - 105.7}{10}} \\ = 0.628 \\ = 62.8 \% \cdot load$$

Hence, if 90 voice calls introduces 62.8% load, it is possible to find the expected capacity when the maximum recommended 75% load is achieved. For example:

$${N}_{pole} = \frac{90}{0.628} \\ = 143.2 calls ⇒ {N}_{max\_recommended} \\ = 0.75 \cdot 143.2 \\ = 107.4 calls$$

The estimated maximum voice capacity for the particular cell corresponds to 107.4 calls.

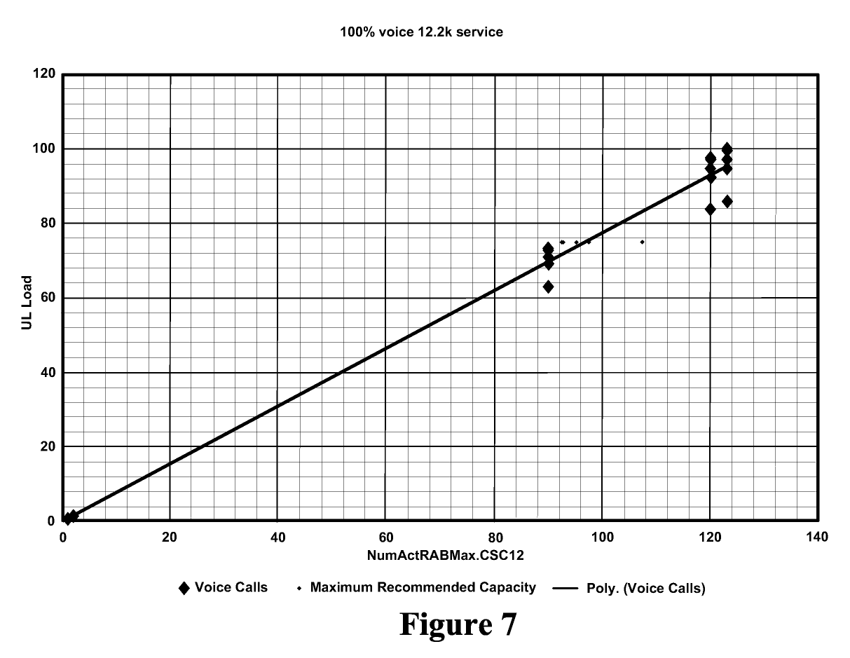

FIG. 7 shows the result of observation of several intervals of time when 100% voice service is in the cell. In FIG. 7, the open diamonds (Voice Calls) correspond to the actual load vs. voice calls, whereas the filled diamonds (Maximum Recommended Capacity) correspond to the estimated capacity for 75% load, and the values fall into a range of values due to the fluctuations of the measurements. The median of those estimations should be the closest to the real maximum capacity, and the accuracy should increase with increasing number of samples, as indicated by a high density of filled diamonds in one particular value or a smaller range. A trend of the observations is indicated by the solid line (Poly. Voice Calls).

Referring back to FIG. 6, in one embodiment, one or more loads may be determined (at 620) for a downlink. In the illustrated embodiment, one or more performance measurements include an indication that NumActRABMean for voice is 8.26 and there is no other service in the cell. The AVE_TSSI performance measurement counter records 23.92% for approximately the same instant of time and a previously recorded value of the performance measurement counter AVE_TSSI when no other users were in the cell corresponds to 18%. Using the above values, the maximum recommended total capacity may be estimated as:

$$DLMaxCapacity = \frac{8.26}{23.92 - 18} \cdot ( 70 - 18 ) = 72.55 \_calls$$

where the 72.55 total calls includes all the soft and/or softer handoff calls and also it assumes calls with an average activity factor equal to the average activity factor of the observed 8.26 calls.

In one embodiment, if a large number of samples are taken over a period of time (several months) during similar busy hours, then it should be possible to estimate the DLMaxCapacity from each sample and extract the median for the large number of samples. The larger the number of samples the more accuracy the estimation gains. Also it may be useful to estimate the average power required per user, since the knowledge could be used in the case of mixed service types discussed in detail below. Following the same example as above, the average power required per user in this case could be estimated as:

$$AvgPowerPerUser = \frac{AVE\_TSSI - CommonChannelsPower}{NumActRABMean} \\ = \frac{23.92 - 18}{8.26} \\ = 0.72 \%$$

The estimated average power required per user in this case corresponds to 0.72%. Again this value may be highly dependent on the user location, therefore if only few RABs are active in the cell the accuracy of this value may decrease.

Whether or not previous loads have been determined (at 620) when a single service type was being provided is determined (at 625). The determined loads may be stored (at 630) if no previous loads have been determined (at 620). For example, the loads may be stored (at 630) in a table such as the results table 310 shown in FIG. 3B. The determined loads may be modified (at 635) if previous loads have been determined (at 620). In various alternative embodiments, modifying (at 635) the loads may include forming various statistical combinations of the current loads and the previously determined loads. For example, the statistical combinations may be formed by learning algorithms that perform operations including, but not limited to, means, medians, window functions, weighting functions, and the like. The modified loads may then be stored (at 640). For example, the modified loads may be stored (at 640) in a table such as the results table 310 shown in FIG. 3B.

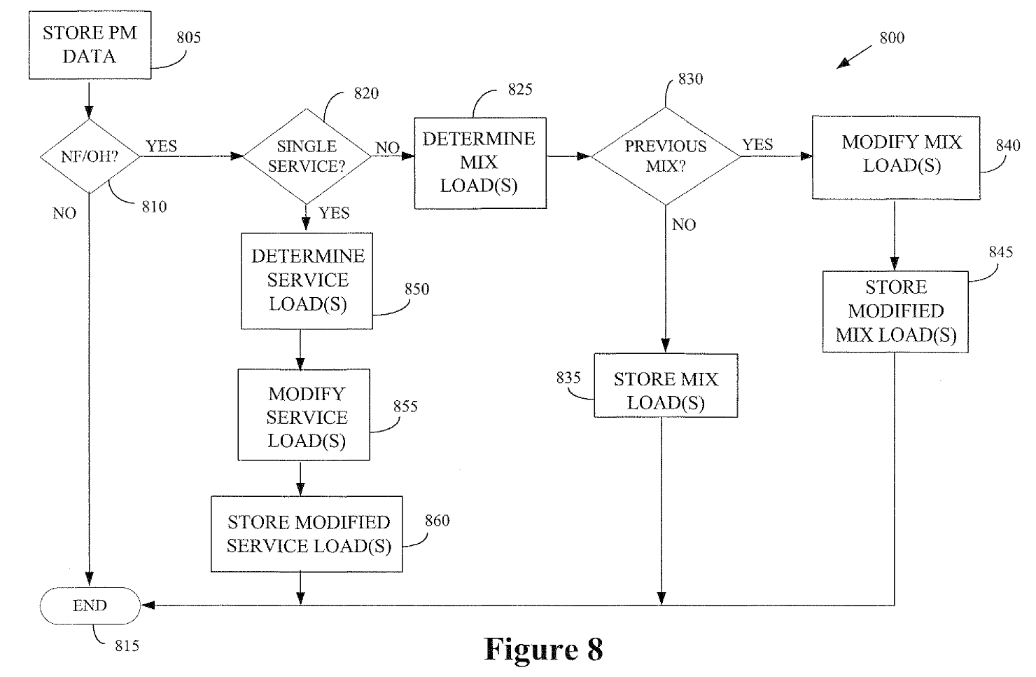

FIG. 8 conceptually illustrates one exemplary embodiment of a method 800 for determining loads associated with service types based upon performance measurements associated with a plurality of service types and/or active bearers. In the illustrated embodiment, the performance measurement data associated with the plurality of service types and/or active bearers is stored (at 805), e.g. in a table such as the data table 300 shown in FIG. 3A. If it is determined (at 810) that there are no previous performance measurements available from time periods when the system had no active bearers and/or was providing no types of service, then the method 800 may end (at 815). If it is determined (at 810) that there are previous performance measurements available from time periods when the system had no active bearers and/or was providing no types of service, then it is determined (at 820) whether or not there are previous performance measurements associated with each of the service types involved in the current traffic mix.

If previous performance measurements associated with each of the service types involved in the current traffic mix are not available, then one or more loads associated with the current mix of service types may be determined (at 825).

In one embodiment, one or more loads associated with the current mix of service types provided on an uplink may be determined (at 825). For example, the “NumActRABMax” performance measurement counter for each service may be used to find the composition of service types in the current traffic, a percentage of each service type, and the like. The load introduced in each period of time can be calculated in the same way as explained previously. The maximum capacity can be calculated for the particular mixture of services. For example, the counters collected in an instant of time may read:
NumActRABMax.CSV12=52
NumActRABMax.CSD=6
NumActRABMax.PS32=0
NumActRABMax.PS64−0
NumActRABMax.PS128=0
NumActRABMax.PS384=1
   Thus, the current traffic mix includes a total maximum of 59 calls with the traffic mix: 88.13% voice+10.17% of 64 kCSD+1.7% of 384 k.

The noise floor may be obtained (as discussed above) by observing the median value of the RSSI when no mobile units are in the network. For example, the noise floor may be RSSIₘᵢₙ_{_{—}}_{dβm}=−105.7 dβm and the actual signal may be measured as: RSSI_{actual}_{_{—}}_{dBm}−−02.8 dBm. In that case, the load would be:

$$Loading ≡ η = 1 - {10}^{\frac{102.8 - 105.7}{10}} = 0.4871 = 48.71 \% \_load$$

Thus, the maximum recommended capacity would be:

$${N}_{pole} = \frac{59}{0.4871} \\ = 121.12 \_calls ⇒ {N}_{max\_recommended} \\ = 0.75 \cdot 121.12 \\ = 90.84 \_calls$$

Applying the traffic mix to the 90.84 calls, the final result corresponds to:
NumActRABMax.CSV12=88.13%=80.06 calls
NumActRABMax.CSD=10.17%=9.24 calls
NumActRABMax.PS384=1.7%=1.54 calls

In one embodiment, one or more loads associated with the current mix of service types provided on a downlink may be determined (at 825). For example, if the performance measurement counter for NumActRABMean (i.e. for 12.2 k voice) is about 18.51 and the performance measurement counter for NumActRABMean (i.e. for 64 k PS service) is about 1.59, then the call percentage corresponds to 92.5% voice and 7.95% 64 kPS. The observed ave_tssi is 37.05% and the percentage for common control channels is about 18%. The mixed capacity is calculated as:

$$\begin{matrix}DLMaxCapacity = \frac{{\sum }_{k = 0}^{NumServ} {NumActRABMean}_{k}}{AVE\_TSSI - CommonChannelsPower} \cdot \\ ( 70 - CommonChannelsPower ) \\ = \frac{18.51 - 1.59}{37.05 - 18} \cdot ( 70 - 18 ) \\ = 54.86 \_calls\end{matrix}$$

The estimated total number of calls corresponds to 54.86 calls now, where each call is weighed as 92.5% voice, i.e. 50.74 voice calls and 7.95% 64 k PS calls, i.e. 4.36 calls of 64 k PS.

Whether or not previously determined loads associated with approximately the same mix of services are available may be determined (at 830). In one embodiment, determining (at 830) whether or not previous loads associated with approximately the same mix of services are available comprises determining whether or not the mix of services associated with previous loads is within a tolerance of the current mix of services. For example, if the current mix of services is 92.5% voice and 7.95% 64 k PS calls, then the current mix of services may be associated with any mix of services within a range of 90-100% voice and 0-10% 64 k PS calls. The determined mix loads may be stored (at 835) if no previous loads have been determined. For example, the loads may be stored (at 835) in a table such as the results table 310 shown in FIG. 3B. The determined loads may be modified (at 840) if previous loads have been determined. In various alternative embodiments, modifying (at 840) the loads may include forming various statistical combinations of the current loads and the previously determined loads. For example, the statistical combinations may be formed by learning algorithms that perform operations including, but not limited to, means, medians, window functions, weighting functions, and the like. The modified loads may then be stored (at 845). For example, the modified loads may be stored (at 845) in a table such as the results table 310 shown in FIG. 3B.

If previous performance measurements associated with each of the service types involved in the current traffic mix are available, then loads associated with the each of the service types may be determined (at 850).

In one embodiment, loads associated with the each of the service types may be determined (at 850) for an uplink. Moreover, the capacity for a variety of possible service mixtures may be determined (at 850) using performance measurements. It is also possible to apply the loads determined using a single service type (e.g. the method 600 shown in FIG. 6) to be able to calculate the capacity for any given mixture. In one embodiment, when only one service is available, the noise contribution of such service can be computed and stored. When a mixed scenario is in the network, it is possible to apply the knowledge of single scenarios to estimate the recommended maximum single capacity of the rest of the services in the mixture and also the noise contribution of the single services. When the information for each single service is collected it is possible to find the maximum recommended capacity for any type of mixture. For example, assuming a single service scenario at some instant of time, the noise contribution of voice may be calculated to determine that approximately 90 voice calls introduces about a 62.8% load. For another example, a service mix scenario at some instant of time may include a mixture of 52 voice calls (88.13%), 6 calls of 64 k CSD (88.13%) and 1 call of 384 k (1.7%). Thus, the mixed service scenario has a total load of about 48.71%.

Information from the single-service and mixed-service scenarios may then be combined. In one embodiment, a learning algorithm may be used to combine information from the various scenarios. For example, if 90 voice calls introduces 62.8% load, then 52 voice calls introduces 36.28% load. Therefore, a 36.28% load out of the total 48.71% is due to voice uses, and the remaining 12.43% load is generated by the seven data calls: six 64 k CSD (85.71% of the total 7 calls) and one 384 k PS call (i.e. 14.3% of the total 7 calls). This technique can be applied to a mixture of 64 k CSD and 384 k PS to find the recommended maximum capacity for such mixture: 85.71% 64 kCSD and 14.3% of 384 k PS. If a single service scenario is found during some performance measurement period, e.g. for a 384 kPS data transfer rate, it would be possible to calculate the noise contribution of the service by following the aforementioned procedures. Applying this knowledge together with the previous single voice knowledge may make it possible to estimate the noise contribution due to 64 k CSD and the maximum recommended capacity for the single service. Once the noise contribution is found for each single service, it is possible to calculate the maximum recommended capacity for any mixture.

In one embodiment, loads associated with the each of the service types may be determined (at 850) for a downlink. For example, an estimated average power required per voice calls may be 0.72%, as discussed above, in which case an estimated 18.51 voice calls may require an average 13.33% of power. The power left for the 1.59 calls at 64 k PS is 5.72% and it is calculated as a result of subtracting the power required for voice calls and the common control channels power from the performance measurement counter AVE_TSSI. Once the average power required per call for 64 k PS service has been determined, the maximum recommended total capacity can be also estimated. For example, the maximum recommended total capacity for 64 k PS may be estimated to be 14.44 calls for this particular sample. As mentioned before, this capacity includes calls in soft and/or softer handoff and it also assumes that the average activity of the call is the same as the average activity observed in the sample.

In the examples above 2% blocking is assumed when the cell power reaches 70%. However, persons of ordinary skill in the art should appreciate that this may not be the case in all embodiments and there may be some variation in blocking from cell to cell. By obtaining measurements of the blocking as a function of cell power spread over several weeks/months the calculations can be made more accurate. Further refinement of calculations can be achieved by use of more complex algorithms.

The loads associated with each service type may be modified (at 855) using the newly determined loads for each service type. In one embodiment, the determined single service loads may be modified (at 855) if previous single service loads have been determined. In various alternative embodiments, modifying (at 855) the loads may include forming various statistical combinations of the current loads and the previously determined loads. For example, the statistical combinations may be formed by learning algorithms that perform operations including, but not limited to, means, medians, window functions, weighting functions, and the like. The modified single service loads may then be stored (at 860). For example, the modified single service loads may be stored (at 860) in a table such as the results table 310 shown in FIG. 3B. Although not indicated in FIG. 8, in one embodiment, one or more loads associated with the current mix of service types provided on a downlink may be, determined (at 825) after modified single service loads have been stored (at 860), as discussed above.

Embodiments of the invention described above may have a number of advantages over conventional practice. For example, an operator of a wireless telecommunications system may be in control of traffic in each sector and be aware of the remaining capacity associated with each sector. In particular, the operator may use capacity forecast reports formed on a per sector basis using one or more embodiments of the present invention. Operators may also be able to decide when and where a network upgrade may be required due to growing traffic. Accordingly, expensive and/or early investments in infrastructure, as well as customer dissatisfaction due to performance degradation, may be reduced. Furthermore, operators may be able to launch specific services based on a better understanding of the remaining capacity for each service type in the wireless telecommunications system.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for use in a wireless telecommunications network that provides a plurality of service types, comprising:
accessing a network performance measurement associated with the wireless telecommunications network; and
determining a load associated with at least one of the service types based on the accessed performance measurement.

2. The method of claim 1, wherein accessing the network performance measurement comprises accessing a network performance measurement counter.

3. The method of claim 2, wherein accessing the network performance measurement counter comprises accessing performance measurement counter indicative of at least one of a number of users, a maximum number of active radio access bearers, a mean number of active radio access bearers, a number of call requests, a number of dropped calls, and a number of denied call requests.

4. The method of claim 2, wherein accessing the network performance measurement counter comprises selecting a performance measurement counter indicative of at least one of a received signal strength indicator, a transmitted signal strength indicator, a percentage of average transmit power, and a percentage of required power to support at least one common control channel.

5. The method of claim 1, wherein determining the load associated with at least one of the service types comprises determining a number of active radio bearers.

6. The method of claim 5, determining the load associated with at least one of the plurality of service types comprises determining of a noise floor or an overhead in response to determining that there are no active radio bearers.

7. The method of claim 5, wherein determining the load associated with at least one of the plurality of service types comprises determining a number of service types associated with the active radio bearers.

8. The method of claim 7, wherein determining the load associated with at least one of the plurality of service types comprises determining a load associated with one service type in response to determining that only one service type is associated with the active radio bearers.

9. The method of claim 7, wherein determining the load associated with at least one of the plurality of service types comprises determining a plurality of loads associated with a plurality of service types in response to determining that a plurality of service types are associated with the active radio bearers.

10. The method of claim 1, wherein accessing the network performance measurement comprises accessing a performance measurement associated with at least one of an uplink and a downlink.

11. The method of claim 10, wherein determining at least one load associated with at least one of the plurality of service types comprises determining at least one capacity.

12. The method of claim 11, further comprising storing said at least one capacity associated with at least one of the uplink and the downlink in a table.

13. The method of claim 1, further comprising determining a capacity of the wireless telecommunications network based upon the load.

14. The method of claim 13, further comprising storing the capacity of the wireless telecommunications network in a table.

15. The method of claim 1, comprising accessing a second network performance measurement, wherein the second network performance measurement was performed after the first network performance measurement.

16. The method of claim 15, further comprising modifying a load based on the second performance measurement.

17. The method of claim 16, further comprising determining a capacity of the wireless telecommunication network based on the modified load.

18. The method of claim 1, further comprising determining whether to upgrade the wireless telecommunication network based on the one load.

19. The method of claim 18, wherein determining whether to upgrade the wireless telecommunication network based on the load comprises determining whether to upgrade the wireless telecommunication network based on a capacity determined on the load.

20. The method of claim 1, wherein determining the load associated with the at least one of the service types comprises using a given maximum of the network performance measurements associated with only a single service type being provided in the period of time.
